(19) United States
(12) Patent Application Publication
(10) Pub. No.: US 2026/0305525 A1
(43) Pub. Date: Oct. 8, 2026

(54) HARVESTER TOPPER HEIGHT ADJUSTMENT SYSTEM AND METHOD

(71) Applicant: Deere & Company, Moline, IL (US)

(72) Inventor: Michael L. Halbrook, Thibodaux, LA (US)

(21) Appl. No.: 19/098,048

(22) Filed: Apr. 2, 2025

(51) Int. Cl. A01D 23/04; A01D 41/127; A01D 45/10

(52) U.S. Cl. CPC A01D 23/04; A01D 41/127; A01D 45/10

(57) ABSTRACT

A harvester including a topper cutter having an adjustable height. A first sensor is positioned on the harvester to sense an upper portion of crop and configured to generate a first signal indicative of a dielectric constant of the upper portion. A second sensor is positioned to sense a lower portion of the crop and configured to generate a second signal indicative of a dielectric constant of the lower portion. A controller is in communication with the first and second sensors and is configured to receive the first and second signals, assess a height of the topper cutter based on the first and second signals, and execute a corresponding response strategy.

### FIELD OF THE DISCLOSURE

The present disclosure relates to a sugarcane harvester and more particularly to a sugarcane harvester topper cutter height adjustment system.

### BACKGROUND

A sugarcane harvester severs sugarcane plants from the ground with a base cutter assembly and transports the severed plants to a set of chopping drums that chop the severed plant into smaller billets. The billets are sent through a cleaning arrangement to separate the billets from non-billet material such as leaves, dirt, and other trash. Passing through the cleaning system, the billets are then discharged, for example, to be transported or stowed in a trailing vehicle. Prior to severing the sugarcane from the ground, a topper cuts the leafy tops off the sugarcane stalks thereby preventing the leaves from being ingested with the stalks into the chopping drums and end up as trash in the harvested billets.

### SUMMARY

In one implementation of the present disclosure, a harvester includes a topper cutter having an adjustable height. A first sensor is positioned on the harvester to sense an upper portion of crop and configured to generate a first signal indicative of a dielectric constant of the upper portion. A second sensor is positioned to sense a lower portion of the crop and configured to generate a second signal indicative of a dielectric constant of the lower portion. A controller is in communication with the first and second sensors and is configured to receive the first and second signals, assess a height of the topper cutter based on the first and second signals, and execute a corresponding response strategy.

In one example of this implementation, assessing the height of the topper cutter includes determining whether or not a differential between the first signal and the second signal is greater than or equal to a minimum target. In a second example, when the differential is greater than or equal to the minimum target the response strategy includes not adjusting the height of the topper cutter. In a third example of this implementation, when the differential is less than the minimum target the response strategy includes adjusting the height of the topper cutter. In a fourth example, when the first signal is above a lower threshold (e.g., the first signal is converging on the second signal) the response strategy includes adjusting the height of the topper cutter upward. In a fifth example of this implementation, when the second signal is below an upper threshold (e.g., the second signal is converging on the first signal) the response strategy includes adjusting the height of the topper cutter downward. In a sixth example, the first and second sensors are both mounted on the topper cutter and are raised and lowered therewith when the topper cutter is raised and lowered. In a seventh example, the first sensor is mounted above the second sensor. In an eighth example, the first and second sensors are radio frequency sensors. In a nineth example of this implementation, adjusting the height of the topper cutter includes actuating a hydraulic cylinder.

In another implementation of the present disclosure, a method for controlling a harvester topper cutter includes sensing, via a first sensor, a dielectric constant of an upper portion of crop and sensing, via a second sensor, a dielectric constant of a lower portion of the crop. The method also includes communicating, a first signal indicative of the dielectric constant of the upper portion via the first sensor and a second signal indicative of a dielectric constant of the lower portion via the second sensor. The method further includes assessing a height of the topper cutter based on the first and second signals and executing a corresponding response strategy.

In one example of this implementation, assessing the height of the topper cutter includes determining whether or not a differential between the first signal and the second signal is greater than or equal to a minimum target. In a second example, when the differential is greater than or equal to the minimum target the response strategy includes not adjusting the height of the topper cutter. In a third example of this implementation, when the differential is less than the minimum target the response strategy includes adjusting the height of the topper cutter. In a fourth example of this implementation, when the first signal is above a lower threshold the response strategy includes adjusting the height of the topper cutter upward. In a fifth example, when the second signal is below an upper threshold the response strategy includes adjusting the height of the topper cutter downward. In a sixth example, the first and second sensors are both mounted on the topper cutter and are raised and lowered therewith when the topper cutter is raised and lowered. In a seventh example of this implementation, the first sensor is mounted above the second sensor. In an eighth example, the first and second sensors are radio frequency sensors. In a nineth example of this implementation, adjusting the height of the topper cutter includes actuating a hydraulic cylinder.

### BRIEF DESCRIPTION OF THE DRAWINGS

The above-mentioned aspects of the present disclosure and the manner of obtaining them will become more apparent and the disclosure itself will be better understood by reference to the following description of the implementations of the disclosure, taken in conjunction with the accompanying drawings, wherein:

FIG. 1A is a perspective view of a sugarcane harvester.

FIG. 1B is a side view of the sugarcane harvester of FIG. 1A.

FIG. 2 is a side view of a front portion of the sugarcane harvester topper.

FIG. 3 is a partial perspective view of the sugarcane harvester topper as viewed from underneath.

FIG. 4 is an enlarged partial perspective view of the sugarcane harvester topper as viewed from underneath.

FIG. 5 is an enlarged partial perspective view of the sugarcane harvester topper as viewed from above.

FIG. 6 is a schematic representation of a control system.

FIG. 7 is a graph illustrating upper and lower radar sensor signals corresponding to an optimal topper height.

FIG. 8 is a graph illustrating upper and lower radar sensor signals corresponding to a low topper height.

FIG. 9 is a graph illustrating upper and lower radar sensor signals corresponding to a high topper height.

FIG. 10 is a flow chart illustrating a method of controlling a sugarcane harvester topper height.

Corresponding reference numerals are used to indicate corresponding parts throughout the several views.

### DETAILED DESCRIPTION

Before any implementations of the disclosure are explained in detail, it is to be understood that the disclosure is not limited in its application to the details of construction and the arrangement of components set forth in the following description or illustrated in the accompanying drawings. The disclosure is capable of supporting other implementations and of being practiced or of being carried out in various ways. Also, it is to be understood that the phraseology and terminology used herein is for the purpose of description and should not be regarded as limiting.

A sugarcane harvester severs sugarcane plants from the ground with a base cutter assembly and transports the severed plants to a set of chopping drums that chop the severed plant into smaller billets. The billets are sent through a cleaning arrangement to separate the billets from non-billet material such as leaves, dirt, and other unwanted material. Prior to severing the sugarcane from the ground, the harvester cuts the leaves, or tops, off the sugarcane stalks thereby preventing the leaves from being ingested with the stalks into the chopping drums. The harvester includes a topper which cuts off the top portion of the sugarcane stalks, thereby removing the leafy tops and unwanted foliage before the main stalk is harvested by the rest of the harvester. The topper cuts off the top portion of the sugarcane and discards it to the side of the harvesting row. The height of sugarcane leaves varies due to downed crop, uneven crop growth, and other environmental factors. In some implementations, the topper can be adjusted up and down with respect to the sugarcane to account for the uneven height of the leaves and cut only as much from the sugarcane as necessary.

The present disclosure relates to a sugarcane harvester topper cutter height adjustment system. This system uses a radio frequency sensor arrangement mounted on the topper to measure a differential in the dielectric constant of crop ahead of the topper between upper and lower points. This differential is used to determine the optimal position of the topper to maximize removal of tops without losses of stalk. The measured differential can be compared against a predetermined differential of the dielectric constant between the stalk and tops of sugarcane to define an operating range for the topper that can reduce hunting up and down for the correct position. This sensor configuration can also reduce the need for calibration when the differential in the dielectric constant between the stalk and tops remains relatively consistent whether the sugarcane has high or low water content, thus allowing action from the measured dielectric constant to operate on a percent difference top to bottom rather than a defined value that could change depending on crop conditions.

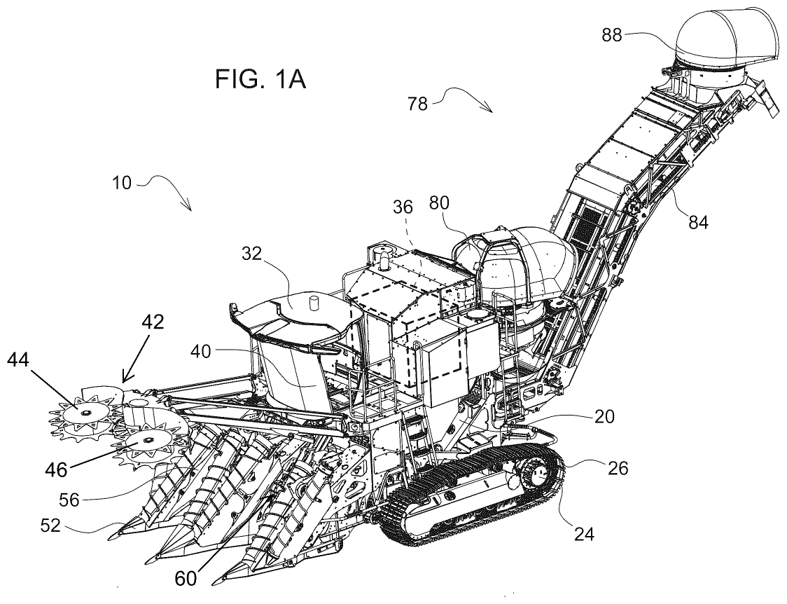

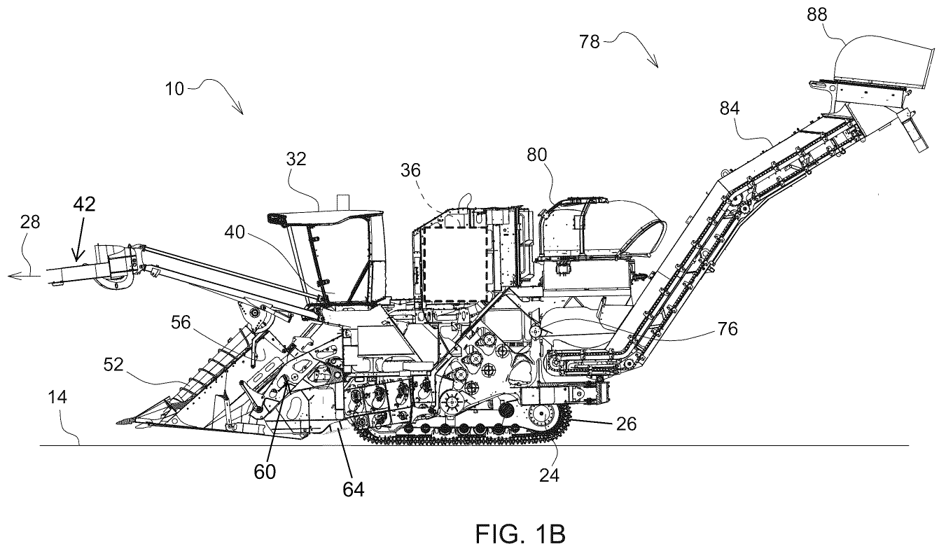

FIG. 1A illustrates a harvester 10, such as a sugarcane harvester, configured to harvest crop from a field 14. The illustrated harvester 10 includes a main frame 20 supported on one or more ground-engaging mechanisms such as wheels 24 or tracks 26 that engage the field 14 in order to move the harvester 10 across the field 14 in a direction of travel 28 (FIG. 1B). In some implementations, the wheels 24 may include continuous tracks 26 or other traction devices. An operator's cab 32 is mounted on the frame 20 adjacent a prime mover 36, such as an engine. The prime mover 36 may be an internal combustion engine or other such device for providing motive power. The harvester 10 includes a throttle control 40 (e.g., a lever, button, switch, pedal, etc.) for controlling a speed of the prime mover 36 and thus a speed of the harvester 10 (also referred to as the harvester speed). The harvester 10 includes a pair of crop lifters 52 mounted to the front of the frame 20, defining an inlet 56 for receiving the crop.

The harvester 10 also includes a topper 42 which cuts off the top portion of the sugarcane stalks, thereby removing the leaves and unwanted foliage before the main stalk is harvested by the rest of the harvester 10. In some implementations, the topper 42 cuts off the top portion of the sugarcane and discards it to the side of the harvesting row. The topper 42 typically includes rotating cutters 44 and 46 that can reach high enough to cut the tops of tall sugarcane plants. After cutting, the severed sugarcane tops are usually discharged to the side of the harvesting row.

FIG. 1B illustrates a side view of the harvester 10 with some portions removed to show the underlying components. The crop lifters 52 cooperate with knockdown roller assemblies 60 and base cutters 64 to remove the crop from the field 14. The harvester 10 further includes a chopper 76, and a cleaning arrangement or cleaning system 78 (also referred to as a residue discharge system) including a primary separator 80 and/or a secondary separator 88. The harvester 10 also includes a conveyor 84 (also referred to as an elevator) connecting the primary separator 80 and the secondary separator 88.

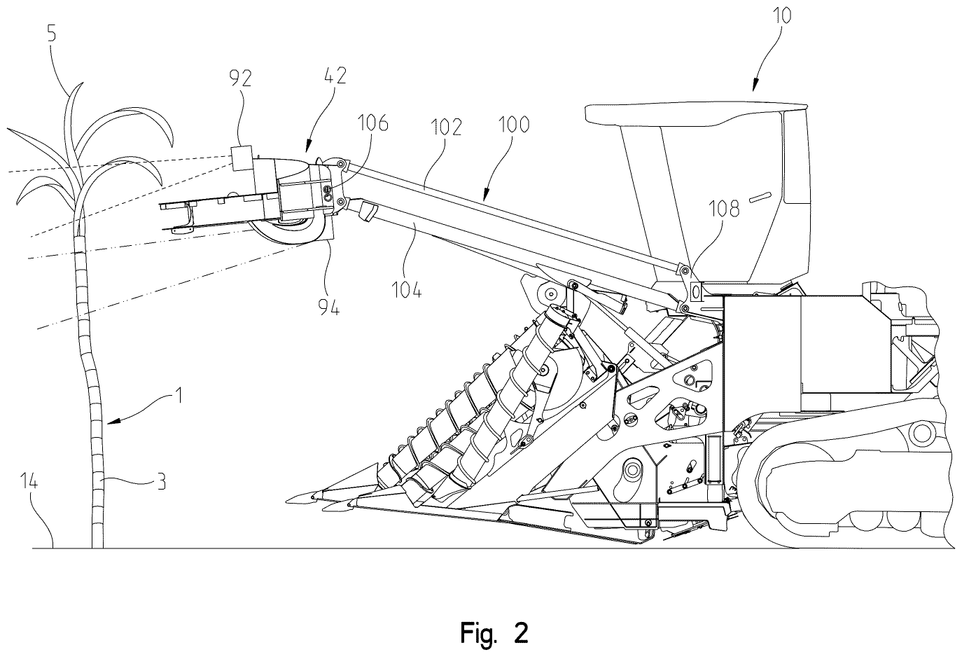

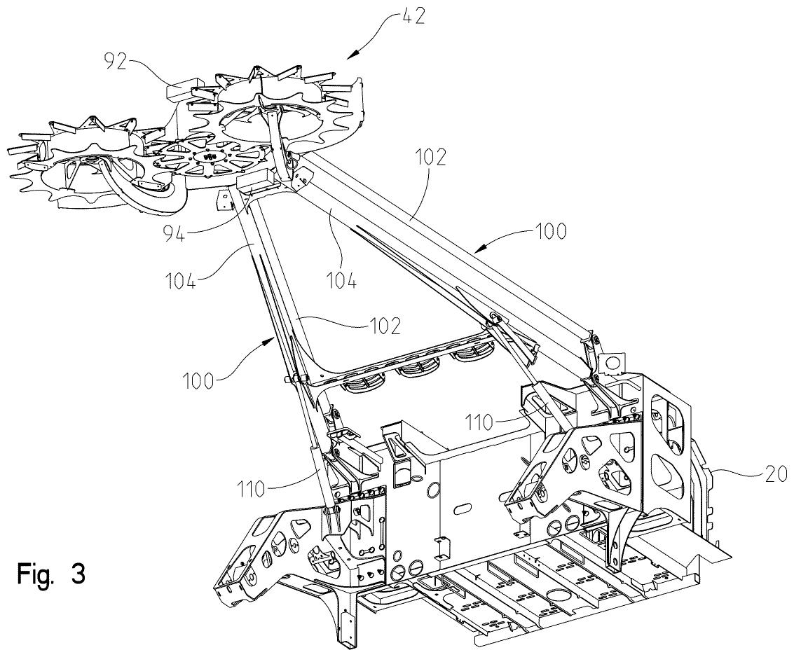

With reference to FIGS. 2 and 3, in some implementations the topper 42 is carried by four-bar linkages 100 that allow the topper 42 to be raised and lowered while maintaining a consistent cutting angle with respect to the sugarcane 1. The elongate members 102 and 104 of the linkages 100 extend approximately parallel to each other between main frame mounts 108 and the topper bracket 106.

In some implementations, the topper 42 includes a first sensor 92 positioned to sense an upper portion of crop (e.g., the sugarcane leaves or tops 5) and configured to generate a first signal indicative of a dielectric constant of the upper portion and a second sensor 94 positioned to sense a lower portion of the crop (e.g., the sugarcane stalks 3) and configured to generate a second signal indicative of a dielectric constant of the lower portion. The sensors can be radio frequency sensors such as radar or ultra wideband radar sensors, for example. Radar techniques can be used to estimate dielectric constants by analyzing the interaction of radar waves with different materials, including travel time, reflection characteristics, and signal strength, for example. Regardless of environmental conditions and crop conditions, the difference in dielectric constant between the tops and stalks of the sugarcane should remain consistent.

As shown in FIG. 3, the topper 42 can be raised and lowered with actuators 110 connected between the main frame 20 and the lower elongate members 104 of the four-bar linkage assemblies 100. In some implementations, the actuators 110 can be linear actuators, hydraulic actuators, electric actuators, mechanical actuators, hydro-mechanical actuators, rotary actuators, electro-mechanical actuators, or any other known type of actuator. The linear actuators 110 move between an extended configuration and a retracted configuration to adjust the height of the topper 42 up and down, respectively.

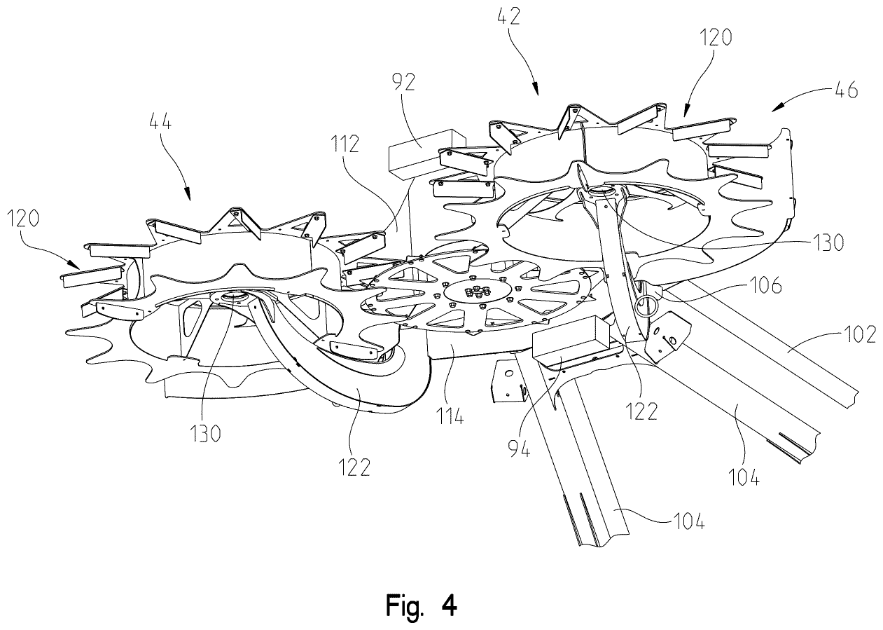

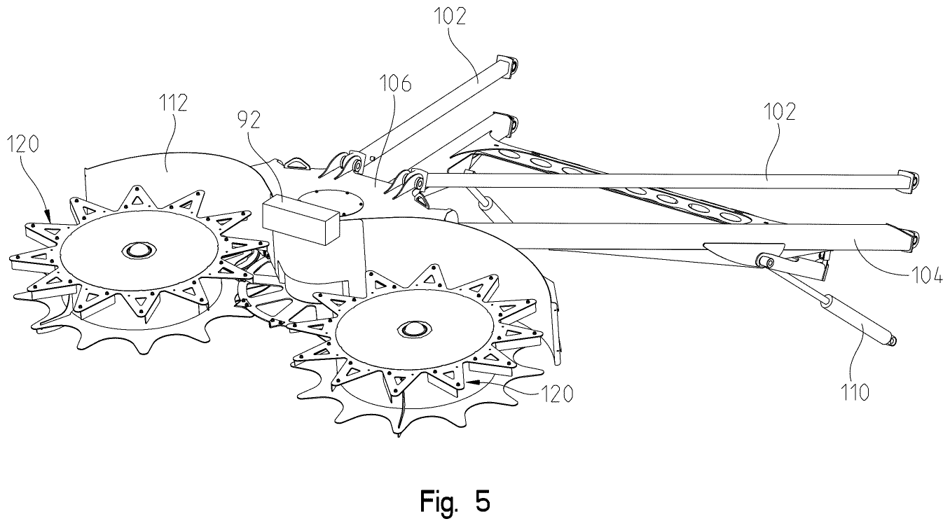

Referring to FIG. 4, the linkage assemblies 100 carry the rotating cutters 44 and 46 via the topper bracket 106. Each cutter 44 and 46 includes a support arm 122 extending from the topper bracket 106 to a rotary actuator such as a hydraulic motor 130 that rotates a cutter blade assembly 120. The topper 42 includes an upper shield 112 and a lower shield 114 to help direct the cut leaves away from the harvester. In some implementations, the lower radar sensor 94 is mounted to the lower shield 114. As best shown in FIG. 5, the upper radar sensor 92 can be mounted to the upper shield 112. The radar sensors 92 and 94 may be coupled to the shields in any known manner (e.g., mechanical fasteners, adhesive, welding, integrally coupled, etc.).

Although the sensors 92 and 94 are shown and described herein as being mounted one above the other, in some implementations the sensors can be mounted at the same level, e.g., both on the upper shield 112, with one sensor aimed towards the leaves 5 of the sugarcane 1 and the other sensor aimed lower towards the sugarcane stalks 3. In another implementation, one of the radar sensors (i.e., the upper sensor 92) can be mounted to the topper 42 while the other radar sensor (i.e., the lower sensor 94) can be mounted below the upper sensor 92 to the frame 20, for example, or an assembly other than the topper cutter 42.

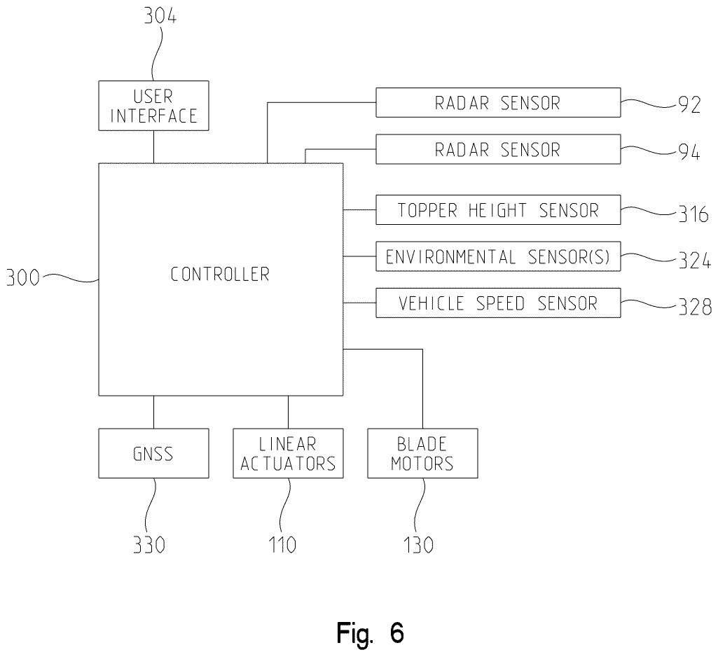

Although not shown in FIGS. 2-4, the radar sensors 92 and 94 may be in communication with a control system including a controller 300 (FIG. 6) which receives outputs from each of the radar sensors 92 and 94. The radar sensors 92 and 94 may be coupled to a power source. In one implementation, the power source may be a battery, such as, for example, a battery housed in the sensor or a hardwired connection to a battery of the harvester 10. In another implementation, the power source may be piezoelectric energy harvesting, thermoelectric energy harvesting, solar power, wind power, or any other method of generating power to a sensor known in the art. In one implementation, the controller 300 may be wirelessly coupled to the radar sensors 92 and 94.

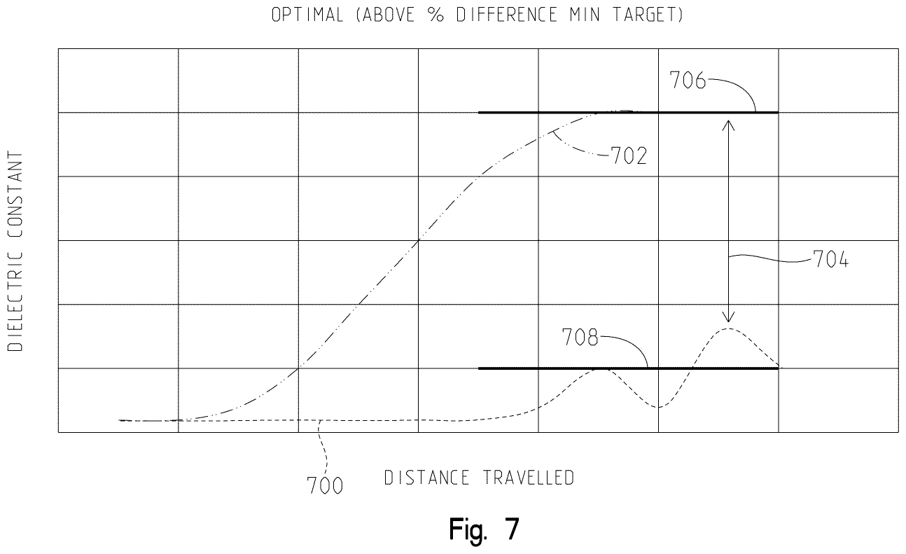

FIG. 6 illustrates a schematic representation of a control system having a controller 300, a user interface 304, and a plurality of sensors 92, 94, 316, 324, and 328. The controller may be located within the harvester 10 and may be incorporated into an electronic control unit (ECU) of the harvester 10, may be electronically coupleable to the ECU, or may be a separate system operable independent of the ECU. The controller 300 may automatically modify one or more of the topper height, knockdown roller height, the base cutter speed, the base cutter angle, and/or a harvester speed based on various inputs from the user interface 304 and signals received from e.g., sensors 92, 94, 316, 324, and 328. Representative control schemes are described with respect to FIGS. 7-10, for example.

With continued reference to FIG. 6, the user interface 304 may be a console located within the operator's cab 32 having one or more inputs such as a touch screen, switches, dials, and buttons that can be actuated by a user/operator for modifying operation of the harvester 10. The user interface 304 is electrically coupled to the controller 300 such that inputs provided by the user to the user interface 304 are transmitted to the controller 300. Additionally, the controller 300 is operable to provide signals that generate outputs at the user interface 304 indicating information (e.g., vehicle status, vehicle performance) calculated, stored in, or otherwise transmitted by the controller 300. In other implementations, changing the topper height, knockdown roller height, the base cutter speed, the base cutter angle, and/or a harvester speed may be manually adjustable (via inputs in the cab and/or manually at the various assemblies).

In some implementations, a topper cutter height sensor 316 can monitor the height of the blades 120 with respect to the ground 14. In some implementations, the angle and height of the blades 120 can be adjusted manually and/or with associated actuators. In an example implementation, the height of the blades 120 are adjusted with the linear actuators 110. In some implementations, the angle of the cutter blades 120 with respect to the ground 14 may be adjusted manually.

One or more environmental sensors 324 may be located on or at a periphery of the harvester 10 to determine different ambient conditions such as temperature, humidity, field conditions such as moisture, soil saturation level, plant density, geographical data, and ground angle/gradient. In some implementations, the environmental sensor(s) 324 may additionally provide some characteristics (e.g., density, weight, height) of the harvested plant. A vehicle speed sensor 328 measures the velocity of the harvester 10. The controller 300 receives signals from the vehicle speed sensor 328 that aids in determining a volumetric throughput of material through the harvester 10. In some implementations, the controller 300 may also receive information from a Global Navigation Satellite System (GNSS) 330, such as global positioning, navigation, and timing information.

In some implementations, the controller is further programmed to provide signals to one or more actuators such as the linear actuators 110 and to the blade motors 130 to modify operational parameters (e.g., topper cutter height, topper cutter speed, and/or a harvester speed) in response to the signals provided by the sensors 92, 94, 316, 324, and 328.

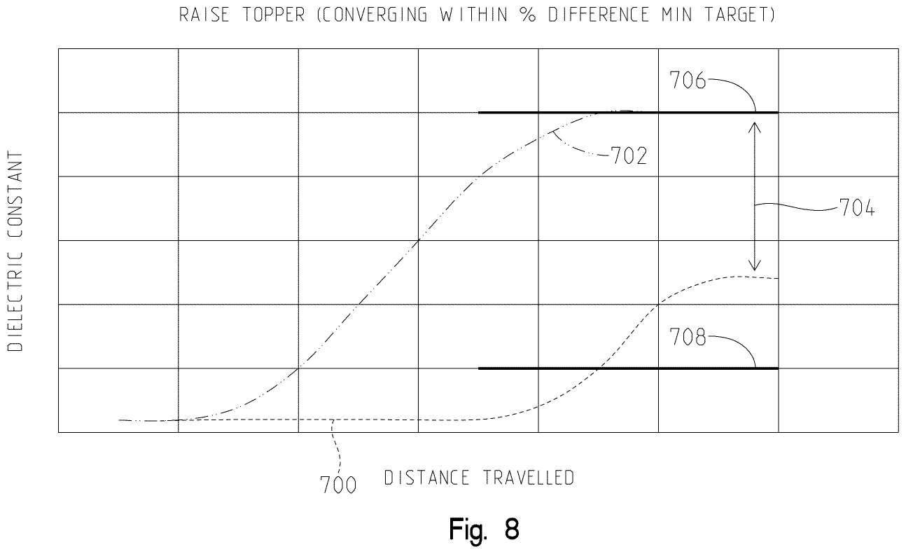

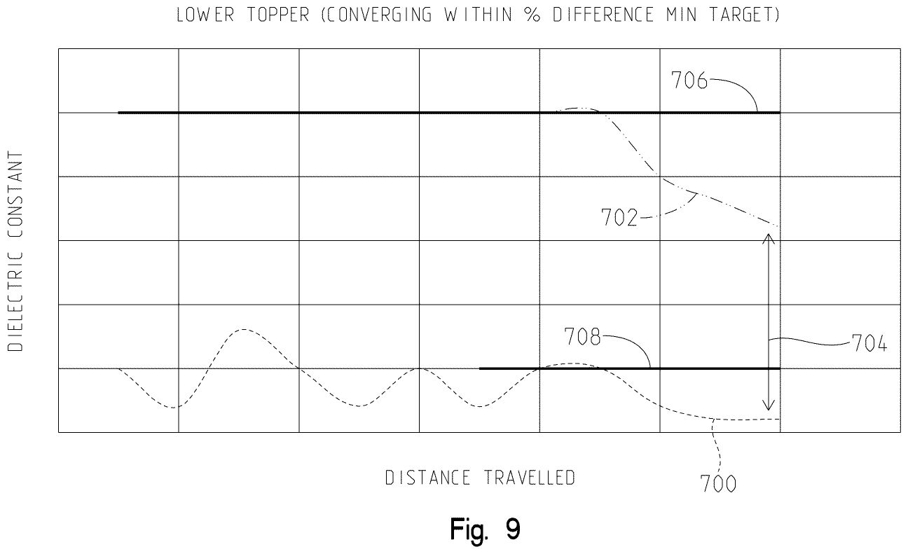

FIGS. 7-9 are graphs illustrating three control scenarios associated with the radar signals from the upper and lower radar sensors 92 and 94. FIG. 7 illustrates a scenario in which the topper height does not need to be adjusted. FIGS. 8 and 9 illustrate scenarios in which the topper height should be raised and lowered, respectively. In the graphs, the X-axis represents Distance Traveled, and the Y-axis represents Dielectric Constant indicated by the signals. As the harvester moves through crop the upper and lower sensors register signals indicative of a dielectric constant of the crop. The upper sensor 92 should register a relatively low dielectric constant associated with the leaves 5 of the sugarcane 1 while the lower sensor 94 should register a relatively high dielectric constant associated with the stalks 3.

With reference to FIG. 7, the topper cutter 42 is at an optimal height when the differential 704 between the upper sensor signal 700 and the lower sensor signal 702 is greater than or equal to a minimum target. When the differential 704 is greater than or equal to the minimum target the topper cutter 42 is at the desired position between the stalks 3 and leaves 5. In other words, the upper sensor 92 is registering the dielectric constant of the leaves 5 and the lower sensor 94 is registering the dielectric constant for the stalks 3.

With reference to FIG. 8, the height of the topper cutter 42 needs to be raised when the differential 704 between the upper sensor signal 700 and the lower sensor signal 702 is less than the minimum target and the upper sensor signal 700 is above a lower threshold 708 indicating that the upper sensor signal 700 is converging toward the lower sensor signal 702. When the differential 704 is less than the minimum target, it indicates that the upper sensor 92 is reading too high or the lower sensor 94 is reading too low. For example, in FIG. 8 the upper sensor signal 700 is too high indicating that sensor 92 is beginning to register the sugarcane stalks 3 rather than the leaves 5 meaning that the topper cutter 42 is too low.

With reference to FIG. 9, the height of the topper cutter 42 needs to be lowered when the differential 704 between the upper sensor signal 700 and the lower sensor signal 702 is less than the minimum target and the lower sensor signal 702 is below an upper threshold 706 indicating that the lower sensor signal 702 is converging toward the upper sensor signal 700. As shown in FIG. 9, the lower sensor signal 702 is too low indicating that the sensor 94 is too high and beginning to register the sugarcane leaves 5 rather than the stalks 3. It may be helpful to understand here too that when the upper sensor signal 700 is below the lower threshold 708 it indicates that the upper sensor 92 is above the leaves 5 and is registering the dielectric constant of the air above the sugarcane leaves.

In some implementations, the minimum target value, and the upper and lower thresholds 706 and 708 can be determined empirically through experimentation and/or calibration. For example, prior to harvesting, the topper 42 can be positioned near sugarcane 1 and then raised and lowered to determine minimum and maximum dielectric constants for the sugar cane 1. In some embodiments, the minimum target value can be set as some percentage, e.g., 75%, of the difference between the maximum and minimum. In some implementations, the upper and lower thresholds 706 and 708 can correspond to the maximum and minimum or can be some percentage thereof.

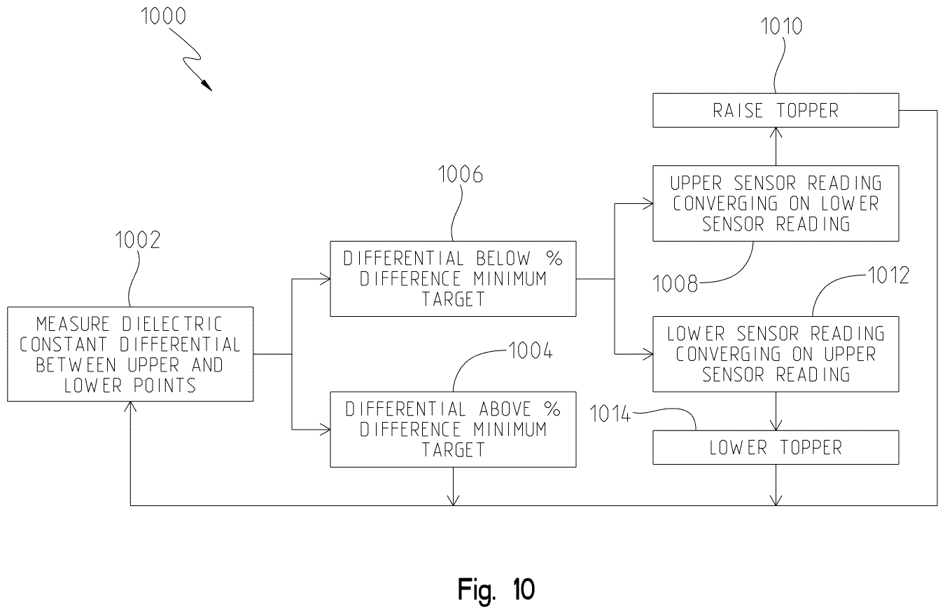

FIG. 10 illustrates one implementation of a method 1000 for controlling the height of a sugarcane harvester topper cutter. The method 1000 may include a set of instructions or blocks that are executable by a controller 300 or operator of a harvester. The controller 300 may be located on the harvester or remote therefrom. The controller 300 may include a memory unit and a processor unit. The memory unit may be capable of storing algorithms, models, processes, programs, software, look up tables, data, charts, diagrams, etc. In some implementations, the method 1000 may include additional or fewer blocks. In another implementation, the blocks may be executed in a different order.

The method 1000 begins at block 1002 where a controller 300 measures the dielectric constant differential 704 between upper and lower points on sugarcane crop. This can be accomplished by sensing, via a first sensor (e.g., upper sensor 92), a dielectric constant of an upper portion of crop and sensing, via a second sensor (e.g., lower sensor 94), a dielectric constant of a lower portion of the crop and subtracting one from the other. The first sensor is positioned to sense an upper portion of crop and configured to generate a first signal (e.g., upper sensor signal 700) indicative of a dielectric constant of the upper portion and the second sensor is positioned to sense a lower portion of the crop and configured to generate a second signal (e.g., lower sensor signal 702) indicative of a dielectric constant of the lower portion.

Following block 1002, the method advances to one of blocks 1004 and 1006. In block 1004 the controller 300 determines that the differential 704 is above the minimum target. In some implementations, when the differential 704 is above the minimum target the response strategy can include not adjusting the height of the topper cutter 42. Accordingly, after block 1004, the method returns to block 1002 to again assess the height of the topper cutter 42 based on the first and second signals.

In block 1006, the controller 300 determines that the differential 704 is below the minimum target. When the differential 704 is less than the minimum target the response strategy includes adjusting the height of the topper cutter 42. Accordingly, after block 1006, the method advances to one of blocks 1008 or 1012.

In block 1008, the controller 300 determines that the first signal (e.g., upper sensor signal 700) is above the lower threshold 708 (e.g., the first signal is converging on the second signal) indicating that the topper cutter 42 is too low. In this case the response strategy includes adjusting the height of the topper cutter 42 upward in block 1010 (i.e., raise topper). After block 1010, the method returns to block 1002.

In block 1012 the controller 300 determines that the second signal (e.g., lower sensor signal 702) is below an upper threshold 706 (e.g., the second signal is converging on the first signal) indicating that the topper cutter 42 is too high. In this case the response strategy includes adjusting the height of the topper cutter 42 downward in block 1014 (i.e., lower topper). After block 1014, the method returns to block 1002.

During harvesting operations, the controller 300 can make adjustments (e.g., blocks 1010 and 1014) to the machine parameters based on the signals from the upper and lower radar sensors 92 and 94. In some implementations, the controller 300 can adjust the height of the topper 42 by activating the actuators 110 as explained above. In some implementations, the adjustments are automatically performed by the controller 300. In other implementations, the adjustments can be semi-automatic in that the controller 300 can indicate to an operator, e.g., via the interface 304, that certain parameters, e.g., topper height, could be adjusted to optimize harvest quality and allow the operator to authorize or ignore the suggested changes. In still other implementations, the controller 300 can indicate to the operator the certain adjustments could be beneficial and allow the operator to set the parameters that are then changed by the controller and/or allow for manual adjustments to the machine by the operator.

In the present disclosure, the implementations described herein may be used on any agricultural or forestry equipment, for example. While the disclosed technology is shown and described with respect to a sugarcane harvester, other types of harvesters or other equipment can implement this technology where adjusting an implement or assembly relative to parts of a plant (e.g., leaves, stalks, trunks, etc.) is advantageous.

While exemplary implementations incorporating the principles of the present disclosure have been described herein, the present disclosure is not limited to such implementations. Instead, this application is intended to cover any variations, uses, or adaptations of the disclosure using its general principles. Further, this application is intended to cover such departures from the present disclosure as come within known or customary practice in the art to which this disclosure pertains.

What is claimed is:

1. A harvester, comprising:
a topper cutter having an adjustable height;
a first sensor positioned to sense an upper portion of crop and configured to generate a first signal indicative of a dielectric constant of the upper portion;
a second sensor positioned to sense a lower portion of the crop and configured to generate a second signal indicative of a dielectric constant of the lower portion; and
a controller in communication with the first and second sensors, the controller configured to:
receive the first and second signals;
assess a height of the topper cutter based on the first and second signals; and
execute a corresponding response strategy.

2. The harvester of claim 1, wherein assessing the height of the topper cutter includes determining whether or not a differential between the first signal and the second signal is greater than or equal to a minimum target.

3. The harvester of claim 2, wherein when the differential is greater than or equal to the minimum target the response strategy includes not adjusting the height of the topper cutter.

4. The harvester of claim 2, wherein when the differential is less than the minimum target the response strategy includes adjusting the height of the topper cutter.

5. The harvester of claim 4, wherein when the first signal is above a lower threshold the response strategy includes adjusting the height of the topper cutter upward.

6. The harvester of claim 4, wherein when the second signal is below an upper threshold the response strategy includes adjusting the height of the topper cutter downward.

7. The harvester of claim 1, wherein the first and second sensors are both mounted on the topper cutter and are raised and lowered therewith when the topper cutter is raised and lowered.

8. The harvester of claim 1, wherein the first sensor is mounted above the second sensor.

9. The harvester of claim 1, wherein the first and second sensors are radio frequency sensors.

10. The harvester of claim 4, wherein adjusting the height of the topper cutter includes actuating a hydraulic cylinder.

11. A method for controlling a harvester topper cutter, the method comprising:
sensing, via a first sensor, a dielectric constant of an upper portion of crop;
sensing, via a second sensor, a dielectric constant of a lower portion of the crop;
communicating, a first signal indicative of the dielectric constant of the upper portion via the first sensor and a second signal indicative of a dielectric constant of the lower portion via the second sensor;
assessing a height of the topper cutter based on the first and second signals; and
executing a corresponding response strategy.

12. The method of claim 11, wherein assessing the height of the topper cutter includes determining whether or not a differential between the first signal and the second signal is greater than or equal to a minimum target.

13. The method of claim 12, wherein when the differential is greater than or equal to the minimum target the response strategy includes not adjusting the height of the topper cutter.

14. The method of claim 12, wherein when the differential is less than the minimum target the response strategy includes adjusting the height of the topper cutter.

15. The method of claim 14, wherein when the first signal is above a lower threshold the response strategy includes adjusting the height of the topper cutter upward.

16. The method of claim 14, wherein when the second signal is below an upper threshold the response strategy includes adjusting the height of the topper cutter downward.

17. The method of claim 11, wherein the first and second sensors are both mounted on the topper cutter and are raised and lowered therewith when the topper cutter is raised and lowered.

18. The method of claim 11, wherein the first sensor is mounted above the second sensor.

19. The method of claim 11, wherein the first and second sensors are radio frequency sensors.

20. The method of claim 14, wherein adjusting the height of the topper cutter includes actuating a hydraulic cylinder.
